(19) United States
(12) Patent Application Publication
(10) Pub. No.: US 2007/0069518 A1
(43) Pub. Date: Mar. 29, 2007

(54) Connector to limit leakage during cleaning of RV sewer lines

(76) Inventor: John A. Lyons, Quartzsite, AZ (US)

Correspondence Address: Galasso & Associates, LP, P. O. Box 26503, Austin, TX, 78755-0503, US

(21) Appl. No.: 11/237,400

(22) Filed: Sep. 27, 2005

(51) Int. Cl. F16L 21/00

(52) U.S. Cl. 285/401

(57) ABSTRACT

A watertight connector for an RV sewer line and a conventional garden hose is provided to limit or prevent leakage when water from the garden hose is used to clean the sewer line. The connector comprises a cone, a threaded nut, a washer that forms a seal within the nut, a male fitting that fits over a female RV sewer line, and securing pins for securely attaching the male fitting to the sewer line. The nut may be a moveable swivel-type nut or may comprise the material tip of the cone. The user attaches the nut to the tip of a garden hose and the male fitting at the base of the cone to an RV sewer line and secures the fitting with the securing pins. Afterwards, the user turns on the garden hose, so that water from the hose cleans the sewer line without leaking from the connector.

### FIELD OF THE DISCLOSURE

The present invention relates generally to connectors for cleaning sewer lines and more particularly to a connector for limiting or preventing leakage during cleaning of the sewer lines of recreational vehicles with garden hoses.

### BACKGROUND

Recreational vehicles (RVs) or motor homes are popular vehicles used for vacations, retirement, and many forms of recreation. Users typically drive these vehicles to recreational sites designed for their use, plug in the vehicles' electrical lines and sewer lines to connections provided by the sites, and enjoy their stays there. However, a major source of annoyance associated with recreational vehicles is the level of overall maintenance that they require, such as keeping RV sewer lines clean and free from debris. Users must clean these sewer lines as often as possible to maintain sanitary conditions, usually washing them by hand with a water hose. This job is often awkward and difficult because the vehicle's sewer line and the garden hose used to clean it are typically of different diameters, so that they do not fit together to form an effective seal. As a result, the water and the contents of the sewer line are often sprayed onto the user, which is a very unsanitary condition. Moreover, in freezing weather spray from cleaning a sewer line can cause frostbite to the user or result in other hazards such as slippery ice.

Nozzles and connectors of various kinds for better directing flows of liquids and limiting leakage are well known in the art. For example, U.S. Pat. No. 5,170,946 for Rankin provides a shaped nozzle for high velocity fluid flow “formed with a plurality of highly polished and substantially flat surfaces joined together to form a non-circular bore with a non-circular opening.” U.S. Pat. No. 5,833,143 provides a garden hose nozzle with a cylindrical housing, a toothed disk, a shaft member and a fastening bolt.

Moreover, nozzles and connectors designed specifically for cleaning sewer pipes are also known in the art. U.S. Pat. No. 5,720,309 for Baziuk provides a sewer cleaning nozzle that is “connected to a high pressure supply of cleaning fluid, particularly water, and includes high pressure jets directed rearwardly and outwardly relative to a central pipe section connected to an elongate hose so that as the nozzle is pulled through the sewer pipe it washes before materials collected at the base of the pipe.”

However, these nozzles and connectors are typically of complicated designs, making them expensive, and furthermore are not specifically designed for use with the sewer lines of RVs. Therefore, there is a need for a simple, inexpensive, and easy-to-use connector designed to limit or prevent leakage during cleaning of the sewer line of an RV with a garden hose.

### SUMMARY OF THE DISCLOSURE

The following explanation describes the present invention by way of example and not by way of limitation.

It is an aspect of the present invention to provide a connector designed to limit or prevent leakage during cleaning of the sewer line of an RV with a garden hose.

It is another aspect of the present invention to provide a connector, designed to limit or prevent leakage during cleaning of the sewer line of an RV with a garden hose, that is simple in design and easy to use.

These and other aspects of the present invention will become readily apparent upon further review of the following specification and associated drawings. In accordance with the present invention, a watertight connector for an RV sewer line and a conventional garden hose is provided to limit or prevent leakage when water from the garden hose is used to clean the sewer line. The connector comprises a cone, a threaded nut, a washer that forms a seal within the nut, a male fitting that fits over a female RV sewer line, and securing pins for securely attaching the male fitting to the sewer line. The nut may be a moveable swivel-type nut or may comprise the material tip of the cone. The user attaches the nut to the tip of a garden hose and the male fitting at the base of the cone to an RV sewer line and secures the fitting with the securing pins. Afterwards, the user turns on the garden hose, so that water from the hose cleans the sewer line without leaking from the connector.

### BRIEF DESCRIPTION OF THE DRAWINGS

The following embodiments of the present invention are described by way of example only, with reference to the accompanying drawings, in which:

FIG. 1 is a perspective diagram that illustrates a side view of a connector designed to limit or prevent leakage during cleaning of the sewer line of an RV with a garden hose;

FIG. 2 is a perspective diagram that illustrates a cutaway side view of a connector designed to limit or prevent leakage during cleaning of the sewer line of an RV with a garden hose; and

FIG. 3 is a perspective diagram that illustrates a top view of a connector designed to limit or prevent leakage during cleaning of the sewer line of an RV with a garden hose.

### DETAILED DESCRIPTION OF THE DRAWING FIGURES

The following description of drawings is offered to illustrate the present invention clearly. However, it will be apparent to those skilled in the art that the concepts of the present invention are not limited to these specific details. Also, commonly known elements are shown in diagrams for clarity, as examples only and not as limitations of the present invention.

The present invention comprises a connector designed to limit or prevent leakage during cleaning of the sewer line of an RV with a garden hose, providing a watertight seal that prevents spray from exiting onto the user.

In an embodiment, the connector is cone shaped and is manufactured of a lightweight, durable, high-impact material. For example, it may be manufactured from a thermoplastic material such as polyethylene or polypropylene.

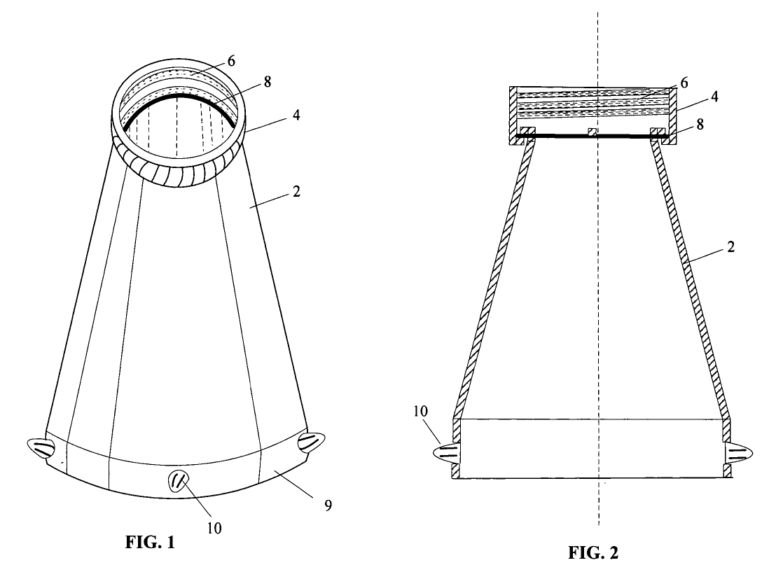

As shown in FIG. 1, the connector comprises the following elements:
A cone 2, and
A threaded nut 4,
A lug-type male fitting 9, and
Securing pins 10.

The threaded nut further comprises
Female threads 6, and
A washer 8.

Returning to FIG. 1, the cone 2 may measure approximately eight inches in length, four inches in diameter at the base, and taper down to one and one fourth inches in diameter at the nut 4.

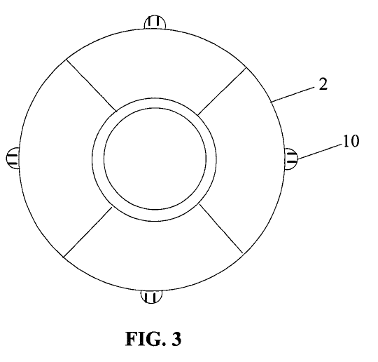

In an embodiment, the nut 4 may be of the swivel-type, attached moveably to the tip of the cone 2, as shown in FIG. 2, so that the nut 4 may be tightened by hand or with a wrench without moving the cone 2. The nut 4 comprises female threads 6 on the inside, so that it can screw onto the male threads of a conventional garden hose. A washer 8, for example a rubber one, forms a seal with the tip of the hose to prevent leakage from the connector when the nut 4 is tightened, typically forming a watertight seal.

In another embodiment, the nut 4 is manufactured as the tip of the cone 2, as shown in FIG. 4, so that turning the nut 4 also turns the cone 2.

The base of the cone 2 comprises a conventional lug-type male fitting 9, with securing pins 10, that fits into a conventional female RV sewer line.

The connector can thus be connected securely to a water hose and a sewer line to limit or prevent leakage.

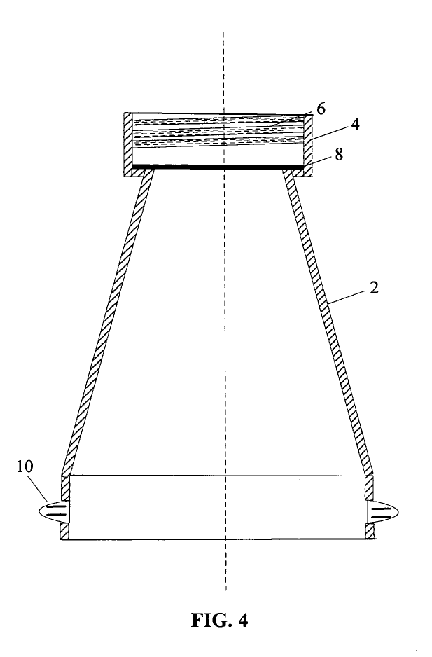

FIG. 3 shows a top view of the connector.

The best dimensional relationships for the parts of the invention described above, including variations in form and use, will be readily apparent to those skilled in the art, and are intended to be encompassed by the present invention.

Use

The user attaches the connector to the male threads of a garden hose by turning the nut 4, shown in FIG. 1, by hand or with a wrench, tightly enough to form a secure seal that will not leak. The user then attaches the lug-type male fitting 9 at the base of the cone to a female RV sewer line and secures the fitting with the securing pins 10. Afterwards, the user turns on the garden hose, so that water from the hose cleans the sewer line without leaking from the connector.

What is claimed is:

1. An apparatus for connecting an RV sewer line and a conventional garden hose such that leakage is limited or prevented when water from the garden hose is used to clean the sewer line, the apparatus comprising
a cone,
a threaded nut such that the nut attaches to the male threads on the tip of a conventional garden hose,
a washer such that the washer forms a seal within the nut,
a male fitting such that the fitting fits over a female RV sewer line, and
at least one securing pin such that at least one securing pin may be used to securely attach the male fitting to a female RV sewer line.

2. The threaded nut of claim 1, wherein the threaded nut comprises a swivel-type nut attached moveably to the tip of the cone, such that the nut may be tightened without moving the cone.

3. The threaded nut of claim 1, wherein the threaded nut comprises the tip of the cone, such that turning the nut also turns the cone.

4. An apparatus for connecting an RV sewer line and a conventional garden hose such that leakage is limited or prevented when water from the garden hose is used to clean the sewer line, the apparatus comprising
a plastic cone measuring eight inches in length,
a swivel-type nut attached moveably to the tip of the cone, such that the nut may be tightened without moving the cone, and attaches to the male threads on the tip of a conventional garden hose, the nut measuring one and one fourth inch in diameter, and being manufactured of plastic,
a washer such that the washer forms a seal within the nut, a male fitting such that the fitting fits over a female RV sewer line, the male fitting measuring four inches in diameter, and
at least one securing pin such that at least one securing pin may be used to securely attach the male fitting to a female RV sewer line.

5. An apparatus for connecting an RV sewer line and a conventional garden hose such that leakage is limited or prevented when water from the garden hose is used to clean the sewer line, the apparatus comprising
a plastic cone measuring eight inches in length,
a threaded nut comprising the tip of the cone, such that the nut when turned also turns the cone, and attaches to the male threads on the tip of a conventional garden hose, the nut measuring one and one fourth inch in diameter, and being manufactured of plastic,
a washer such that the washer forms a seal within the nut, a male fitting such that the fitting fits over a female RV sewer line, the male fitting measuring four inches in diameter, and
at least one securing pin such that at least one securing pin may be used to securely attach the male fitting to a female RV sewer line.
